(19) United States
(12) Patent Application Publication
(10) Pub. No.: US 2022/0333387 A1
(43) Pub. Date: Oct. 20, 2022

(54) HOOKS FOR TOOLS SUCH AS TROWELS

(71) Applicant: Q.E.P. Co., Inc., Boca Raton, FL (US)

(72) Inventors: Bradley Scott Miller, Boca Raton, FL (US); Christopher Thomas Ortega, Boynton Beach, FL (US)

(73) Assignee: Q.E.P.Co., Inc., Boca Raton, FL (US)

(21) Appl. No.: 17/389,436

(22) Filed: Jul. 30, 2021

Related U.S. Application Data
(60) Provisional application No. 63/175,578, filed on Apr. 16, 2021.

(51) Int. Cl. E04F 21/16; B25G 1/08

(52) U.S. Cl. CPC E04F 21/161; B25G 1/08

(57) ABSTRACT

A trowel having a handle and a blade operably connected to each other, and a hook for securing the trowel to the lip of a container in which the hook includes at least three sections extending generally in the same direction. The first section is positioned a greater distance from the blade than the second and third sections and the second and third sections are spaced apart a distance less than the thickness of the handle. The trowel is secured to the container lip with the first section preferably outside the container and the second and third sections preferably inside the container.

### BACKGROUND OF THE INVENTION

This disclosure relates to a hook for securing a tool, such as but not limited to trowels for use with masonry products, where the masonry products are scooped out of a large bucket or other container having an upper lip. While the hook is described and illustrated in the context of a trowel and bucket, no such limitation on the use of the hook is intended. For example, a hook may be used with a paint brush and an open container of paint.

In the context of masonry and tile setting, the masonry product is frequently mixed and maintained in a large bucket or container. The masonry product may be grout or other setting material and is applied with a trowel. Typically, a 5 gallon (18.93 liter) circular bucket is used having a height of 15 inches (38.1 cm) and a diameter of 12 inches (30.48 cm). It should be appreciated that the foregoing dimensions are presented for illustrative purposes.

Previously, a hook was suggested for use with a trowel so that the trowel could be secured onto the lip or rim of the bucket and would extend into the bucket. The benefits of course are (a) to ensure that drippings from the trowel fall into the interior of the bucket and (b) to keep the handle of the trowel away from those drippings so that the handle remains clean and easy to work with. Prior trowels with hooks are described in U.S. Pat. No. 6,393,650 and U.S. Pat. No. 5,706,546, the entirety of both of which are hereby incorporated by reference.

However, the prior hooks had limitations depending on factors such as the thickness of the lip on the bucket. Furthermore, the prior hooks did not properly protect the worker from the drippings and did not provide the worker with the ability to apply the degree of pressure needed to apply the masonry product.

### SUMMARY OF THE INVENTION

The present invention overcomes the shortcomings of the prior art trowel hook and provides numerous benefits and advantages such as a more reliable and more secure fit between the hook and a bucket to minimize undesirable movement of the trowel. Another benefit and advantage of the present invention is the provision of an extension on the hook so that the user may apply suitable pressure when using the trowel, i.e., when applying grout or the like.

### BRIEF DESCRIPTION OF THE DRAWINGS

The foregoing benefits and advantages of the present invention, together with other benefits and advantages that may be attained by its use, will become more apparent to those of ordinary skill in the art upon reading the following detailed description of the invention taken in conjunction with the drawings.

In the drawings:

FIG. 1 is a partial front angled view of a trowel secured to the lip of a bucket by a hook;

FIG. 2 is a partial side view of a trowel secured to the lip of a bucket by a hook;

FIG. 3 is a side perspective view of a trowel and hook;

FIG. 4 is a plan view of the trowel and hook; and

FIG. 5 is an end view of the trowel and hook.

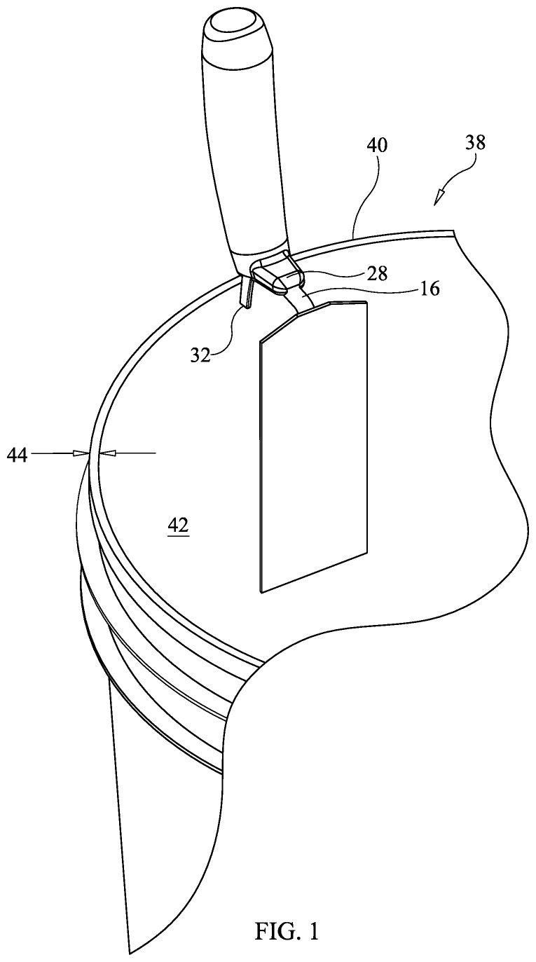

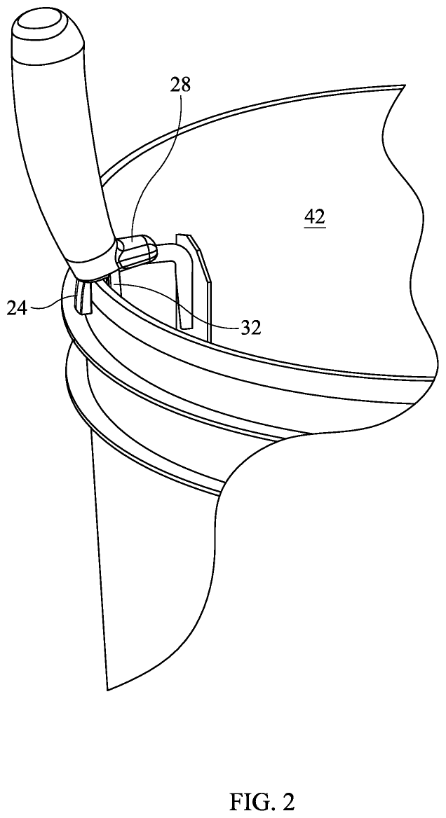

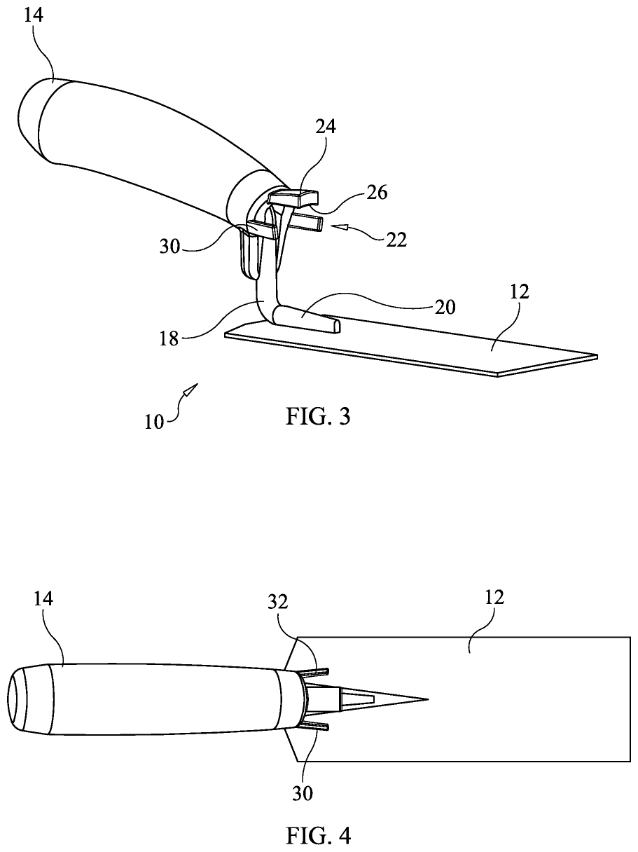

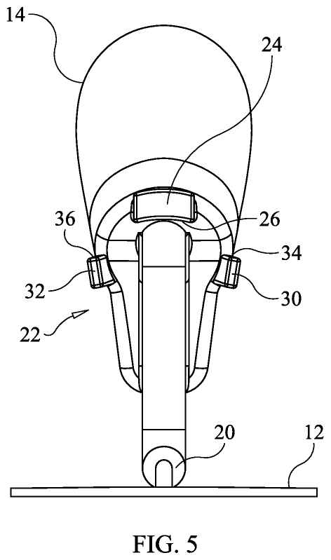

### DETAILED DESCRIPTION

The following description is non-limiting in all respects and is presented for the purpose of illustrating the concept of the improved hook and one hand tool, namely a trowel, and the use of the improved hook with the trowel.

Referring to the drawings a trowel 10 includes a blade 12 and a handle 14. The blade has first and second ends and the handle has first and second ends. The first end of the blade is operably connected to the first end of the handle. In one embodiment, a stem 16 connects the blade first end to the handle first end. The stem 16, which may be L-shaped, thus has one section 18 secured to the blade 12 and the other section 20 secured to the handle 14. It should be appreciated that the trowel, stem and handle may be formed as a unitary structure. The blade may be of suitable shape such as triangular or rectangular. The underside of the blade, i.e., the portion of the on the opposite side of the stem portion 18, is essentially flat as conventional. to the first end of the handle.

A hook 22, in one non-limiting embodiment, may include four sections or portions. A first section 24 is positioned to extend generally outwardly from the handle first end, in a direction opposite to the free end. The first section is spaced above the trowel blade 12 and extends generally parallel to the trowel blade. The underside 26 of the first section 24, that is the portion of the first section that is closest to the trowel blade, may preferably have a slight curvature to generally correspond to the curvature of the exterior of a bucket. Thus, in the example presented above with a bucket having a diameter of 12 inches (30.48 cm), the bucket will have a radius of curvature of 6 inches (15.24 cm) and the underside 26 of the first section 24 may be formed with a similar radius of curvature. It is important to appreciate, however, that while some curvature of the underside 26 is preferred but the curvature should not be an exact match with the curvature of a bucket of a certain size, but may be slightly greater, to allow the hook 22 from being appropriately secured to buckets of different sizes. The first section 24 has a length, from the handle first end and extending away from the handle second end of approximately 0.71 inches (18.1 mm) a width of approximately 0.53 inches (13.4 mm) and a thickness of approximately 0.49 inches (12.5 mm).

The hook 22 includes a section 28 extending generally perpendicular to the handle and extending downwardly from the handle first end. The hook second section is preferably in contact with the second section 20 of the stem 16. This section 28 is referred to as the fourth section as it is optional.

The second and third sections 30, 32, of the hook extend generally parallel to the first section 24. These sections are positioned closer to the trowel blade 12 than the first section 24 and are spaced apart from each other. Thus sections 30, 32 are positioned generally in a plane parallel to the first section 22 but closer to the blade 12. The second and third sections are spaced apart from each other a distance generally the same as the width of the handle 14.

The second and third sections 30, 32 each have a top portion 34, 36 defined as the portion closest to the first section 24. Each of these top portions 34, 36 preferably may have a slight curvature to generally correspond to the curvature of the exterior of a bucket but again, it is important to appreciate that while some curvature is preferred, the curvature should not be an exact match with the curvature of a bucket of a certain size but should be less than the curvature of the bucket to allow the hook 22 from being appropriately secured to buckets of different sizes. The second and third sections each have a length of approximately 0.53 inches (13.4 mm), a width of approximately 0.24 inches (6.0 mm), and a thickness of approximately 0.21 inches (5.4 mm). The lateral spacing or gap between the second and third sections is approximately 0.52 inches (13.1 mm).

The use of the hook 22 will now be explained in the context of a container such as a bucket 38. The bucket is preferably of circular cross section having a wall 40. The bucket typically has a removable top, not shown, and grout or mortar or other material is typically placed within the bucket. The bucket has an interior 42 which is open when the removable top is not present. The wall 40 has a thickness or lip 44 as is conventional.

In use the hook is placed over the wall 44 of the bucket 38 preferably so that the blade 12 is within the interior of the bucket as this is preferred so that any masonry material drips back into the interior of the bucket. However, the blade may be placed outside the wall of the bucket such as when the trowel is clean. The hook 22 is positioned such that the first section 24 of the hook is on one side of the bucket wall and with the second and third sections 30, 32 are positioned on the opposite side of the bucket wall. In the drawings, the trowel is illustrated as being within the interior 42 of the bucket 38. The spacing between the tops 34, 36 of the second and third hook sections and the underside 26 of the first hook section should approximate the thickness 44 of the wall of the bucket. Again, the spacing should preferably not be exact because the wall thickness may not be identical among different buckets with different capacities.

The combination of the first, second and third sections prevent the trowel from tipping over in either direction. For example, if the hook is secured to the lip or wall of the bucket with the trowel inside the bucket, if an accidental inward force is applied to the handle 14, the hook sections 30, 32 will tend to resist the trowel from tipping into the bucket. Similarly, if an accidental outward force is applied to the handle 14, the hook section 24 will tend to resist the trowel from tipping outwardly of the bucket.

Furthermore, the first section 24 provides an additional and unexpected benefit. The first section 24 provides a thumb rest where pressure may be applied by the person using the trowel. In addition, the fourth section 28 provides a support surface for the fingers or hand of the person using the trowel.

The trowel blade 12 is typically made of metal. The trowel handle 14 may be metal, plastic, rubber or wood. The hook 22 may be formed as part of the handle or formed separately and attached to the handle. The hook 22 may be formed of metal, plastic, rubber or wood. Alternatively, the blade, step, hook and handle may be formed as a unitary structure and then a suitable cover placed on the handle for the comfort of the user.

The foregoing is a complete description of a preferred embodiment of the present invention. Many changes and modifications may be made by persons of ordinary skill in the art after consideration of the drawings and description.

What is claimed is:

1. A hook for a trowel, the trowel having a handle with first and second ends and a blade having first and second ends, the first end of the handle being operably connected to the first end of the blade, the hook for suspending the trowel on the lip of a container, the hook comprising:
a first section, a second section and a third section,
the first section extending in a first direction;
the second and third sections each extending in a first direction and generally parallel to the first section; and
the second and third section being spaced apart from each other and spaced apart from the first section.

2. The hook of claim 1, wherein a part of the first section is curved concavely toward the second and third sections.

3. The hook of claim 1, wherein a part of the second section and a part of the third section are each curved convexly toward the first second.

4. The hook of claim 1, and further including a fourth section oriented generally perpendicular to the first, second and third sections.

5. The hook of claim 1, wherein the second and third sections are spaced apart from each other a distance less than the thickness of the handle.

6. A trowel having a handle with first and second ends and a blade having first and second ends, the handle first end being operably connected to the blade first end, the trowel further including a hook comprising:
a first section, a second section and a third section;
the first section extending in a first direction from the handle first end toward the blade second end;
the second and third sections each extending in a first direction from the handle first end toward the blade second end;
the first section positioned a first distance from the blade; and
the second and third sections positioned a second distance from the blade;
wherein the second distance is less than the first distance.

7. The trowel according to claim 6, wherein the second and third sections are spaced apart from each other in a direction perpendicular to said first direction.

8. The trowel according to claim 7, wherein the first section includes a generally concave surface relative to and facing the second and third sections.

9. The trowel according to claim 8, wherein the second and third sections each include a generally convex surface relative to and facing the first section.

10. The hook of claim 6, and further including a fourth section oriented generally perpendicular to the first, second and third sections.

11. The hook of claim 6, wherein the second and third portions extend generally from the handle first end toward the blade second end.

12. The hook of claim 6, wherein the second and third sections are spaced apart a distance less than the thickness of the handle.

13. A trowel having a handle with first and second ends and a blade having first and second ends, the handle first end being operably connected to the blade first end, the trowel further including a hook for securing the trowel to the lip of a container comprising:
a first section, a second section and a third section;
the first section extending in a first direction from the handle first end toward the blade second end;
the second and third sections each extending in a first direction from the handle first end toward the blade second end;
the first section positioned a first distance from the blade; and
the second and third sections positioned a second distance from the blade;
wherein the second distance is less than the first distance and wherein the second distance is approximately equal to or greater than the thickness of the container.

14. The trowel of claim 13, wherein the first section includes a curved surface where the radius of curvature is approximately equal to or greater than the radius of curvature of the container.

15. The trowel of claim 13 , wherein the second and third sections each include a curved surface where the radius of curvature is approximately equal to or less than the radius of curvature of the container.
